(19) United States
(12) Patent Application Publication
(10) Pub. No.: US 2011/0162434 A1
(43) Pub. Date: Jul. 7, 2011

(54) COMPOSITE CALIBRATION/VERIFICATION GAUGE AND METHOD OF ITS MANUFACTURE

(76) Inventor: Shalabh Kumar Rastogi, Gurgaon (IN)

(21) Appl. No.: 13/057,878

(22) PCT Filed: Sep. 29, 2008
(86) PCT No.: PCT/IN08/00630

§ 371 Date: Feb. 7, 2011

(30) Foreign Application Priority Data
Aug. 18, 2008 (IN) 1946/DEL/2008

(51) Int. Cl. G01B 3/30; B23Q 17/00

(52) U.S. Cl. 73/1.81; 29/407.01

(57) ABSTRACT

The present invention relates to a combination calibration/verification gauge for calibrating measuring instruments with a measurement precision. More particularly, the present invention relates to a multi-function, multi-dimension length standard and works as a working standard to compare various measuring instruments on the shop floor.

### FIELD OF INVENTION

The present invention relates to a composite calibration/verification gauge for calibrating measuring instruments with a measurement precision. More particularly the present invention related to a multi-function, multi-dimension length standard, and works as a working standard to compare various measuring instruments at shop floor.

### BACKGROUND OF THE INVENTION

Gauge blocks have been employed as a most common length standard when measuring an accurate length dimension. A gauge block is required to have excellent abrasion and corrosion resistance because it is the standard for the accurate measurement of a dimension. If the gauge block is worn or eroded, it cannot be useful as a standard any longer.

However, according to such a conventional method, there are problems with the gauge blocks, they are expensive, comes in various shapes/sizes, available in sets like 5, 10, 19, 34, 47, 88, 103, 112, 122 pieces etc. Gauge blocks have to combine to make different sizes, it needs special skill to combine them called wringing, sometimes during combination of gauge blocks error takes place because all size calculation process is human dependent and time taking job. Apart from that as maximum gauge blocks are meant for external flat surface measurement, so measurement of a internal diameter is a difficult exercise, furthermore sometimes to get desired results in measurement with gauge blocks you need other instruments like gauge block accessories, sine bar, master cylinder etc.

Features on the gauge assembly available for enabling calibration must, of course, be compatible with the overall construction of the gauge and within any known gauge construction has been accomplished in a variety of arrangements by different manufacturers. Various adjustable gauge blocks have been proposed for machines, wherein the gauge blocks can be set for establishing a desired dimension at which the workpiece is to be cut/set. Some of these gauge blocks are normally slidably mounted on the table and held at a selected position by a set screw.

While these gauge blocks have been satisfactory for their intended purpose, but they have been characterized by certain disadvantages in that it can be time consuming to slide the block to a particular location and then to tighten the set screw to fix the gauge block at a precise location adjacent a scale on the table to establish the desired dimension. After considerable research and experimentation, the gauge block of the present invention has been devised, which is versatile, composite in nature with no loosen accessories/assembly and easily calibrate/verify different measuring instruments at shop floor.

BROWN & SHARPE TESA SA in a Japanese specification JP2003194501 discloses reference gauge for calibrating measuring machine and calibration method for measuring machine. A calibration fork body which has been calibrated comprises, as main components, three block gauges, a base, and a cap, with the three block gauges superposed together while a central block gauge is dislocated much from the other two. The assembly of the three block gauges is symmetrically positioned against the calibration fork body which has been calibrated, with a protrusion of the block gauge disposed at the center. Due to the assembly of the three block gauges, the reference dimension can be measured by the outside dimension of the protrusion as well as by the inside dimension of the measured calibration fork body.

KRISTENSEN, Gerhard in a PCT publication WO8602993 discloses a method and a measuring element system for preparing so-called working gauges or masters with an accuracy of the magnitude 1 ‘mu’. The invention provides for a system comprising both special standard gauge blocks and special working gauge members as well as an associated specialized measuring device, by means of which a working gauge may be produced by a simple length adjustment of two mutually fixably displaceable elements, this adjustment being effected in the measuring device by comparison with the dimension of a standard gauge block as beforehand measured out in the measuring device. The gauge blocks and the working gauges may be similarly shaped, viz. consisting of a cylindrical body and a measurement defining pin projecting thereform, this conditioning a cheap design of the gauge blocks and an easy adjustability of the working gauges.

### SUMMARY OF THE INVENTION

Therefore, it is the purpose of the invention to provide a measuring element system, which may widely simplify and ensure the manufacturing of articles with correct length measurements of high precision, and is versatile and composite in nature.

According to the invention, for the provision of a working standard or master use is made of one or more length variable and fixable master units, which, in a measuring gauge and not under laboratory conditions, are adjusted and fixed at a length dimension corresponding to the length of a calibrated gauge as measured in the same or a corresponding measuring instruments, whereby the calibrated gauge includes laid together, conventional gauge blocks. The measuring instruments include Vernier Caliper, Digital Caliper, Micrometer, Height Gauge, Depth Gauge, Bore Gauge, Internal Caliper, External Caliper, Micrometer Head, Dial Indicator, Dial Test Indicator, Bevel Protractor, Try Square, V-Block and Angle Plate etc.

Therefore such as herein described there is provided a composite calibration/verification gauge for calibrating different measuring instruments in a shop floor comprises of: a plurality of steps in the front portion; a plurality of elliptical bores on the steps in different directions; at least one pin on the topmost step; at least one central stepped bore parallel to the bottom and present on the side of the gauge; a plurality of smaller steps in line with the base of the pin on the top most step; and at least one tapered angle formed at one side of the said steps present in the front portion.

Also there is provided a method for the production of the composite calibration/verification gauge comprises the steps of: providing of the raw materials of desired block; checking the chemical composition of the raw material; cutting the raw material as per the disclosed design; performing basic milling on the cut material; performing heat treatment for obtaining desired hardness of the material; performing sub zero treatment for better dimensional stability; checking of the hardness of the material; performing grinding operation to the different portions of the gauge; performing lapping and finishing operation on the different portions of the gauge; calibrating the gauge with different masters/standard gauges; marking on the different portions of the gauge; performing packing and dispatch of the finished calibration/verification gauge.

As per another object of the present invention there is provided a composite calibration/verification gauge, which is versatile, having a plurality of dimensional standard, bore standard and angle standards.

As per another object of the present invention there is provided a unique sleek designed calibration/verification gauge which is compact with no loosen accessories/assembly.

As per another exemplary object of the present invention there is provided a composite calibration/verification gauge which does not need special skills to handle, any person with some basic knowledge of inspection & measurement can handle it very easily.

As per another object of the present invention there is provided a composite calibration/verification gauge which is simple in construction and all related dimensions are duly marked on the gauge, wherein required.

As per another exemplary embodiment of the present invention there is provided a method for the manufacture of the composite calibration/verification gauge.

As per another exemplary object of the present invention, wherein the method further provides all sides of the composite calibration/verification gauge usable and precisely lapped and duly marked with their respected sizes, wherein required.

As per another exemplary object of the present invention there is provided a composite calibration/verification gauge which comprises a plurality of measuring steps, best suited for large number of measuring instruments with different ranges, models and least counts for various applications, provided by the leading standard instruments manufacturing companies worldwide.

As per another exemplary object of the present invention there is provided a composite calibration/verification gauge which is made of hardened steel material having less wear and tear.

As per another exemplary object of the present invention there is provided a composite calibration/verification gauge which is low cost so very useful to small scale industry, workshop and those who cannot spend lot's of money on periodic calibration, spare instruments, skilled people and standard room with controlled environment for calibration.

As per another exemplary object of the present invention there is provided a composite calibration/verification gauge wherein the user can adjust their instruments or they can use a multiplying factor to compensate bias.

As per another exemplary object of the present invention there is provided a composite calibration/verification gauge wherein the gauge can be used to evaluate measurement system errors like bias, repeatability, stability, linearity etc. at shop floor to analyze measurement variation associated with the measurement system.

As per another exemplary object of the present invention there is provided a composite calibration/verification gauge wherein all non functional areas are 0.2 mm down from the working surfaces, applicable to all sides of the gauge.

As per another exemplary object of the present invention there is provided a composite calibration/verification gauge wherein no special environment is needed to maintain the calibration/verification gauge as it is made of hardened steel, which is same for maximum instruments available in the market, so thermal coefficient of expansion is same.

As per another exemplary object of the present invention there is provided a composite calibration/verification gauge which needs less space due to its unique design with comparison to other standards like Gauge Blocks Sets, Height Masters, Check Masters, Step Gauges etc. so it is easy to maintain in shop floor area.

As per another exemplary object of the present invention there is provided a composite calibration verification gauge which can be calibrated by any length standard with higher accuracy like “0” grade Gauge Blocks Sets or Universal Length Measuring Machine (ULM) etc.

These and other aspects, advantages, and salient features of the present invention will become apparent from the following detailed description, the accompanying drawings, and the appended claims.

### BRIEF DESCRIPTION OF THE ACCOMPANYING DRAWINGS

In the following the invention is described in more detail with reference to the accompanying drawing.

FIG. 1 illustrates the prior art calibration/verification gauges as available;

FIG. 2(a) illustrates the perspective view of the calibration/verification gauge according to the present invention;

FIG. 2(b) illustrates the side view of the calibration/verification gauge according to the present invention;

FIG. 2(c) illustrates the back view of the calibration/verification gauge according to the present invention;

FIG. 2(d) illustrates the other side views of the calibration/verification gauge according to the present invention;

FIG. 3 illustrates the method for the preparation of the calibration/verification gauge according to the present invention;

FIG. 4 illustrates the various measuring instruments which can be calibrate at shop floor with different ranges, least counts and models by using the calibration/verification gauge;

FIG. 5 shows an example illustrating the various measurements of the different portions of the calibration/verification gauge according to the present invention;

FIG. 6(a) shows an example illustrating the method for calibration of Bevel Protractor using the calibration/verification gauge according to the present invention;

FIG. 6(b) shows an example illustrating the method for verification of Try Square using the calibration/verification gauge according to the present invention;

FIG. 6(c) shows an example illustrating the method for calibration of Height Gauge using the calibration/verification gauge according to the present invention;

FIG. 6(d) shows an example illustrating the method for verification of Cast Iron Angle Plate using the calibration/verification gauge according to the present invention;

FIG. 6(e) shows an example illustrating the method for calibration of Internal/External Dial Calipers using the calibration/verification gauge according to the present invention;

FIG. 6(f) shows an example illustrating the method for calibration of Dial Test Indicator using the calibration/verification gauge according to the present invention;

FIG. 6(g) shows an example illustrating the method for calibration of Plunger Type Dial Indicator using the calibration/verification gauge according to the present invention;

FIG. 6(h) shows an example illustrating the method for calibration of Internal Diameter Checking Gauge using the calibration/verification gauge according to the present invention;

FIG. 6(i) shows an example illustrating the method for verification of V—Blocks using the calibration/verification gauge according to the present invention;

FIG. 6(j) shows an example illustrating the method for calibration of Depth Gauges using the calibration/verification gauge according to the present invention;

FIG. 6(k) shows an example illustrating the method for calibration of Outside Jaws of Vernier Calipers using the calibration/verification gauge according to the present invention;

FIG. 6(l) shows an example illustrating the method for calibration of Outside Jaws of Digital Calipers using the calibration/verification gauge according to the present invention;

FIG. 6(m) shows an example illustrating the method for calibration of Digital Caliper Internal Jaws using the calibration/verification gauge according to the present invention;

FIG. 6(n) shows an example illustrating the method for calibration of Digital Caliper Depth Bar using the calibration/verification gauge according to the present invention.

FIG. 6(o) shows an example illustrating the method for calibration of Micrometer using the calibration/verification gauge according to the present invention.

FIG. 6(p) shows an example illustrating the method for calibration of Micrometer Heads using the calibration/verification gauge according to the present invention.

### DETAILED DESCRIPTION

Such as herein described, the present disclosure relates to a calibration/verification gauge for calibrating measuring instruments in a shop floor as required. With reference to FIG. 1, which shows the use of multiple calibrating gauges for different instruments, which have great disadvantages, a person skilled in the art will appreciate the importance of calibration of the variety of measuring instruments/sub gauges in a shop floor with a single calibrating gauge having broad and plain parallel surfaces. It is therefore advantageous to make use of a block member having plurality of broad support surfaces and plurality of measuring surfaces and shapes, which may have a very small area or even be almost pin shaped or a likely broad surface which has fixed lengths, tapered angle and multiple bores/steps in a block member shaped.

The present gauge as disclosed is specially designed to accommodate few common lengths, bores, angles used in various measuring instruments. A significant feature of the present invention is that the invention provides for a new type of a “gauge block” which consists of a variety of length standards adjustable during manufacturing stage (not afterwards) and usable with high accuracy, and which is usable both for measuring instruments or masters and for preadjusted gauges for absolute measurements. In connection with the invention, it has been realized that for the relevant use of the calibrated gauges, there is no practical need of a block having broad and plain parallel surfaces, since it is perfectly possible and even advantageous to make use of a block member having plurality of broad support surfaces and measuring surfaces. The gauge does not have any loosen accessories or any assembly parts which may cause error in calibration.

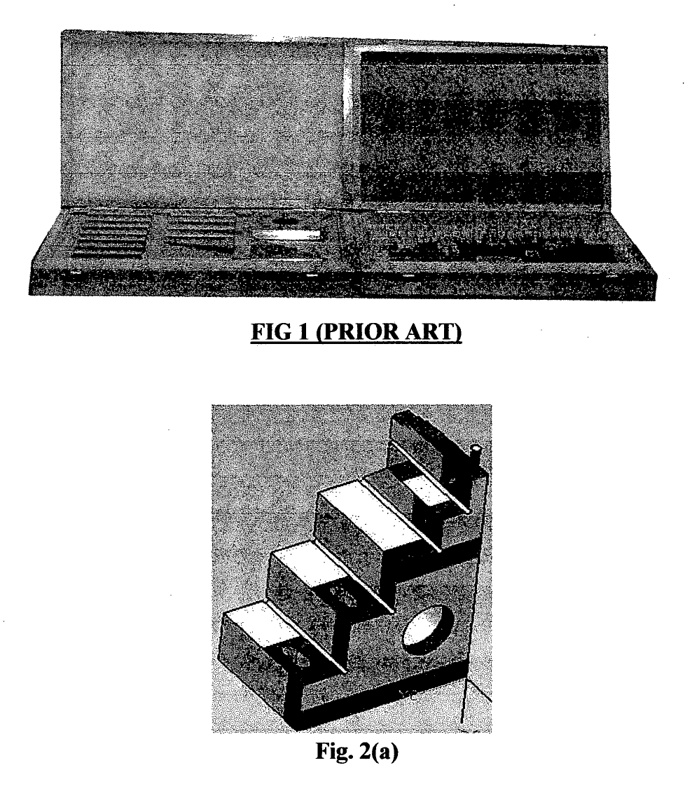

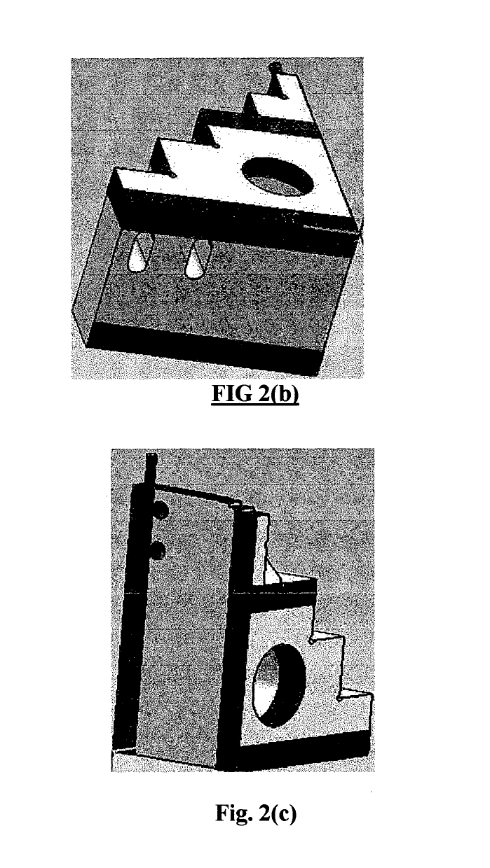

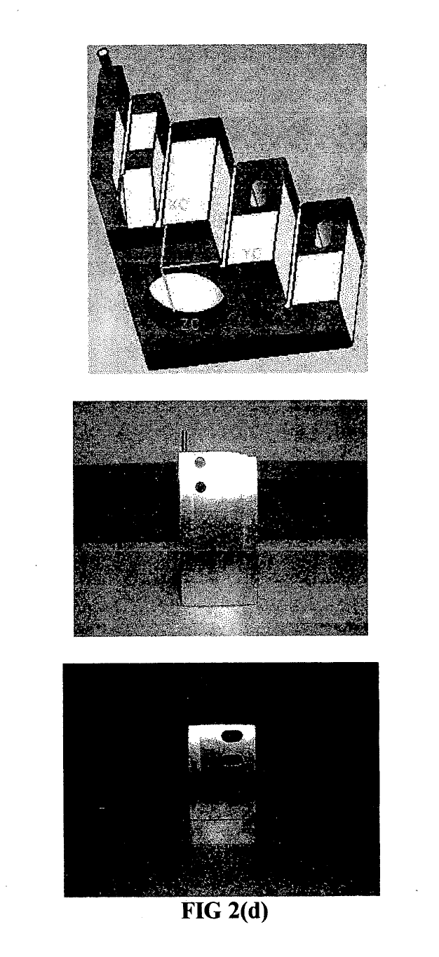

As disclosed the novel design of the calibration/verification gauge comprises of plurality of plain surfaces and further comprising of bores both circular and elliptical shape. The gauge further comprises of a top upright pin. In FIGS. 2(a) to (d) illustrates the different view of the disclosed gauge. The front portion of the calibration gauge comprises of at least five steps of different heights. The first and second step comprises an elliptical bore of same circumferential dimensions. The fourth step is tapered at one end at 45 degrees. The fifth step further comprise of seven small steps and a pin of desired height. These fourth and fifth steps further comprises of circular bores present in the front portion.

As shown in the figure the gauge also comprises of a stepped bore on the side surfaces for calibrating the internal diameter measuring instruments. As per one of the desired objective of the present invention, the calibration/verification gauge is designed with very less complications and to accommodate the maximum numbers of the measuring instruments. All the sides of the calibration gauge are made perpendicular with the adjacent sides and the top sides are made parallel to the bottom sides with maximum accuracy. This bottom surface is polished to a high precision and the central stepped bore is provided at the side is exactly parallel to the bottom plane. The pin is exactly perpendicular to the bottom plane and cylindrical in shape. All working sides of the gauge are chamfered to protect from small mechanical damages/dents and to avoid sharp edges.

The topmost step of the said gauge further comprises of a plurality of small steps, they are used to check Lever Type Dial Indicators, Plunger Type Dial Indicators, Electronic Probes etc. While designing the disclosed gauge the various steps and dimensions can be changed as per specific requirement of customer to give them a regular cross check of their drawing specific dimensions or those dimension which they generally checked everyday in a shop floor. In other words a high degree customization is quiet possible with present unique design of the calibration/verification gauge. Apart from that the gauge can also be helpful to them to conduct various measurement studies at shop floor to analyze measurement variation associated with their measurement system.

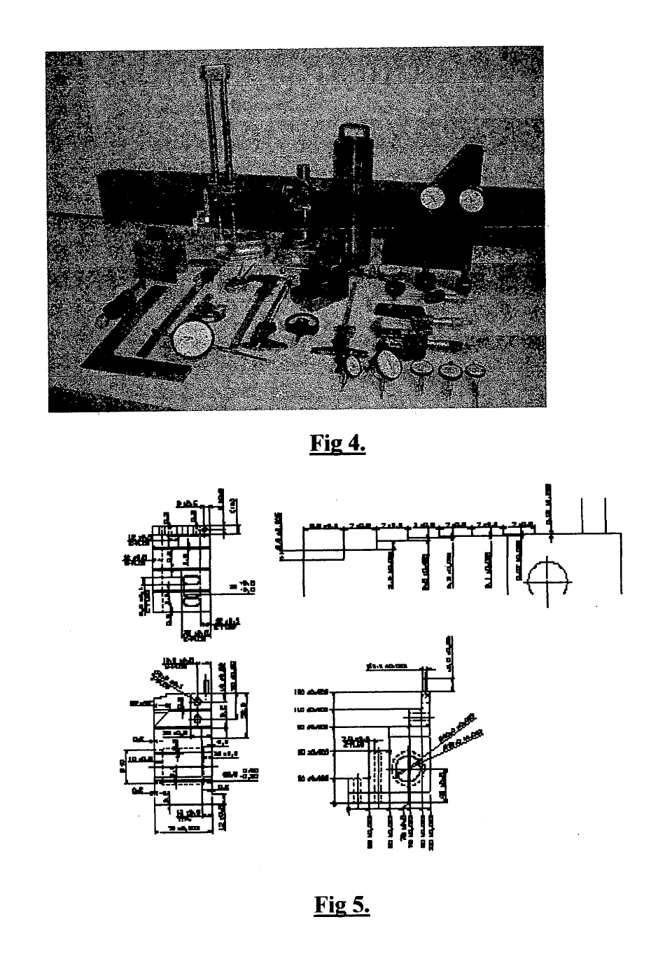

As per another objective of the design the single master gauge comprises with no other loosen accessories/assembly. Furthermore all sides of calibration/verification gauge are usable, precisely lapped & duly marked with their respected sizes wherein required. Due to its simple construction the gauge itself can be customize up to some extent according to few critical applications or user specifications. (For example—bore dia, step heights, step width, angle, pin dia. etc.). Moreover the gauge is very economical and anybody can afford it very easily in comparison to other length standards like Gauge Blocks Sets, ULM and Dial Calibration Tester etc. No portion of the gauge is identified for a particular instrument, because all sides/steps of the gauge can be used in multiple applications for calibration/verification of various measuring instruments with different ranges, models, least count so it works as multifunction & multipurpose gauge. For example, step—25.0, 50.0, 75.0 mm etc. can be used in calibration of Micrometer, Vernier Caliper, Digital Caliper, Plunger Dial Indicator and Height Gauge. There is no need to have lots of masters for each working instrument category & controlled environmental conditions of a lab and is illustrated in FIG. 4. The calibration/verification gauge can be calibrated by any length standard with higher accuracy like “0” grade Gauge Blocks or Universal Length Measuring Machine (ULM) etc.

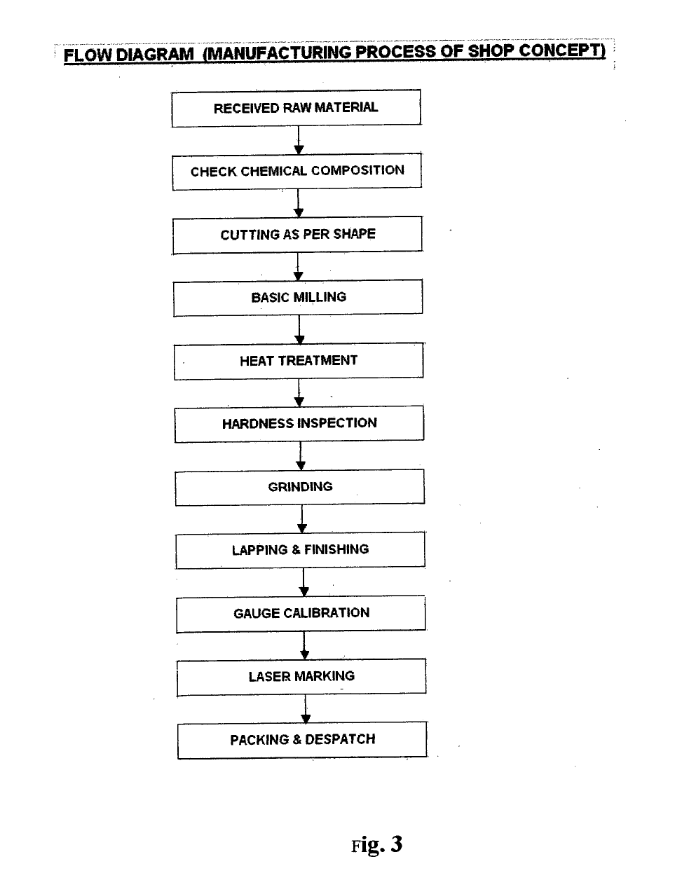

Furthermore as shown in FIG. 3, the method for the production of the disclosed gauge comprises the steps of:—providing of the raw materials of desired block; checking the chemical composition of the raw material; cutting the raw material as per the disclosed design; performing basic milling on the cut material; Performing heat treatment and sub zero treatment for obtaining desired hardness and better dimensional stability of the material; checking of the hardness of the material; performing grinding operation to the different portions of the gauge; performing lapping and finishing operation on the different portions of the gauge; Calibrating the gauge with different master gauges; marking the needed dimensions, cleaning, performing packing and dispatch of the finished gauge.

The raw material chosen for the calibration gauge is high carbon, high chromium, ultra strength steel which causes less wear and tear during operation. On verification of the desired material the raw material block is marked as per the design of the gauge and then cut into the desired shape. For the step design of the disclosed gauge milling operation is carried out and the raw material is heat treated in a pre-heated furnace and then tempered and sub zero treatment to have a desired hardness (value) and dimensional stability. The hardness of the instrument is desirous since the hard material has less wear and tear and can be used for long time. For making the surface smooth, grinding operation is carried out to all the surfaces followed by lapping and polishing of all the surfaces. After the polishing operation gauges are ready and then they are calibrated for the different workable portions using the standard gauges. Then calibrated gauges are marked for the visualization of actual dimension at different portions and then packed and dispatched for the destinations. It may be noted herein that the calibration/verification gauge does not contain any assembly of components therefore it does not contain any loosen accessories.

The calibration/verification gauge can be used to evaluate measurement system errors like bias, repeatability, stability, linearity etc. at shop floor to analyze types of measurement variation associated with the measurement system. Also the gauge material can be changed according to different application or customer requirement as carbide, ceramic etc.

### EXAMPLE

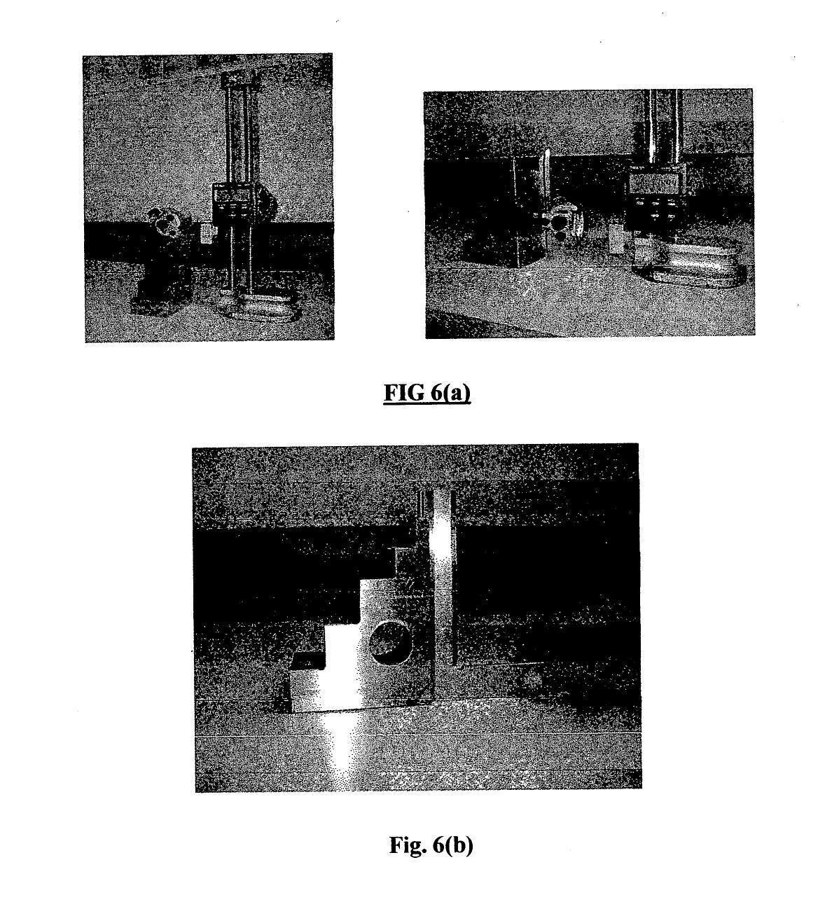

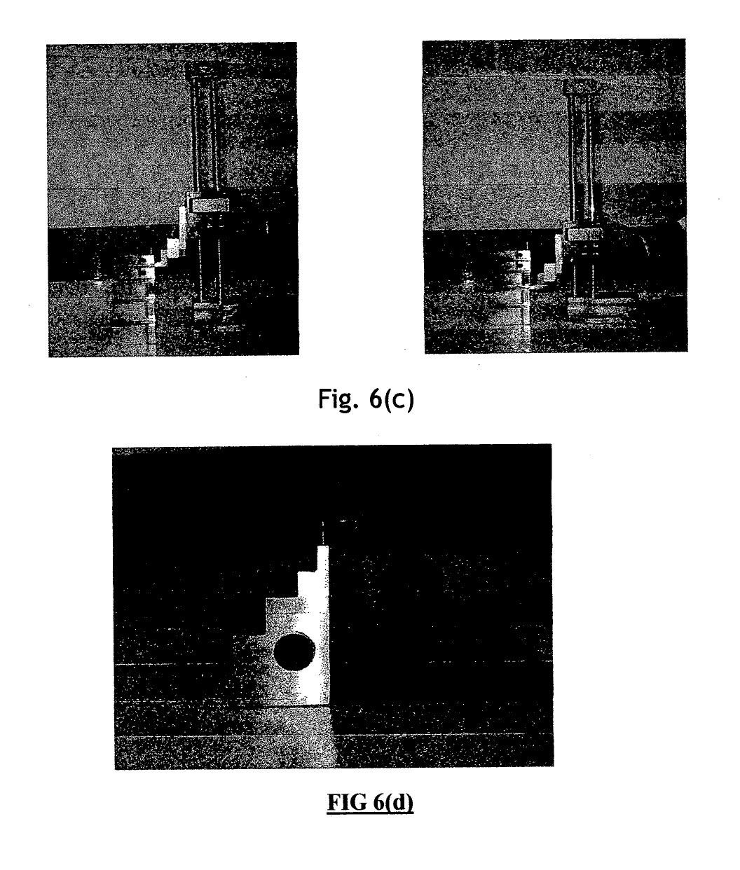

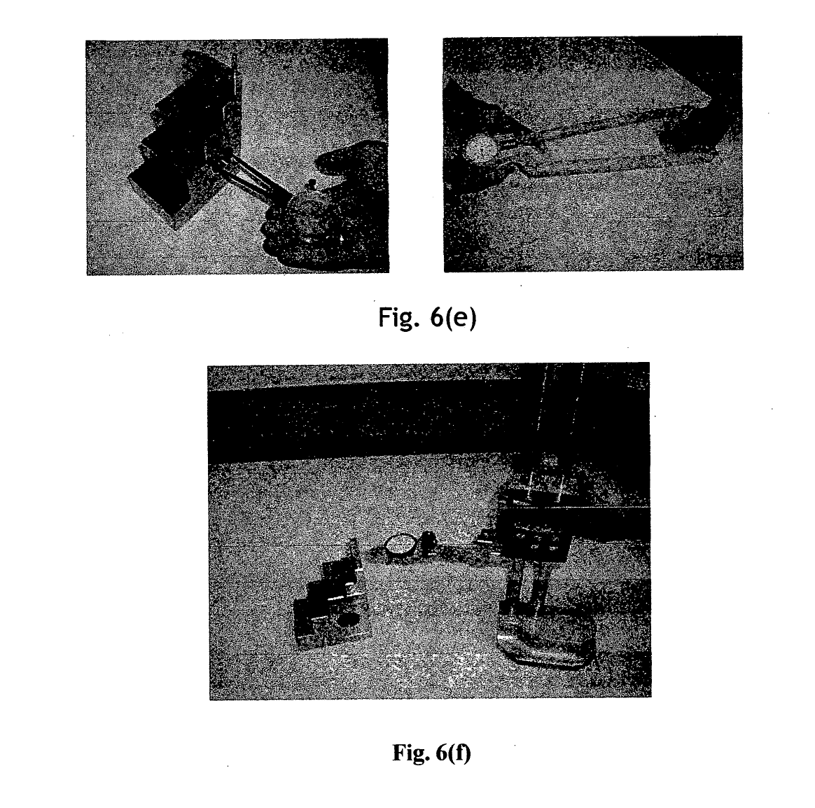

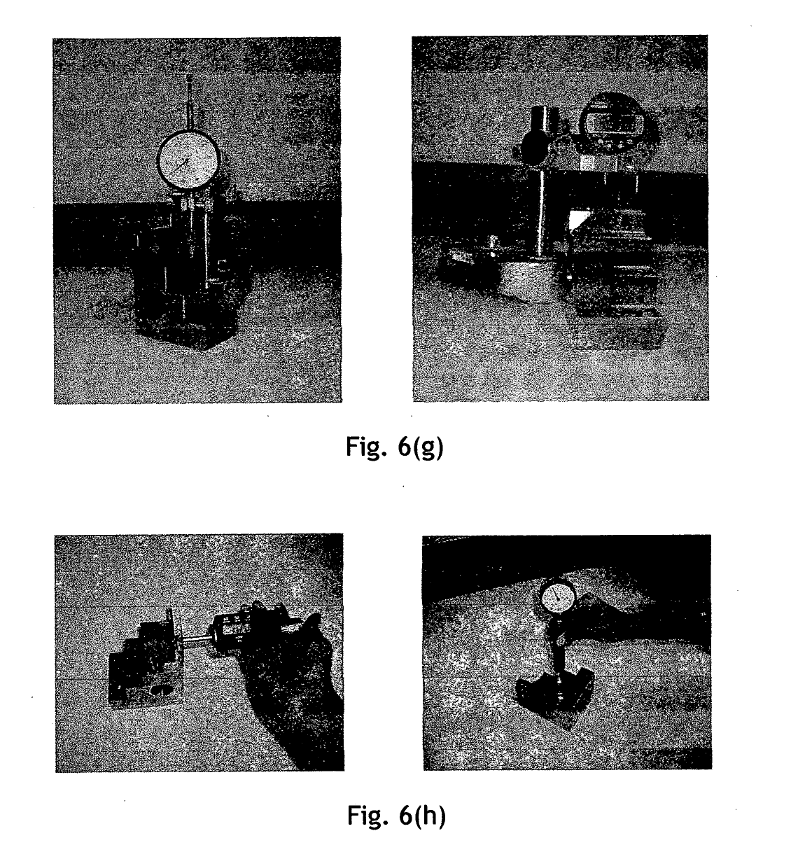

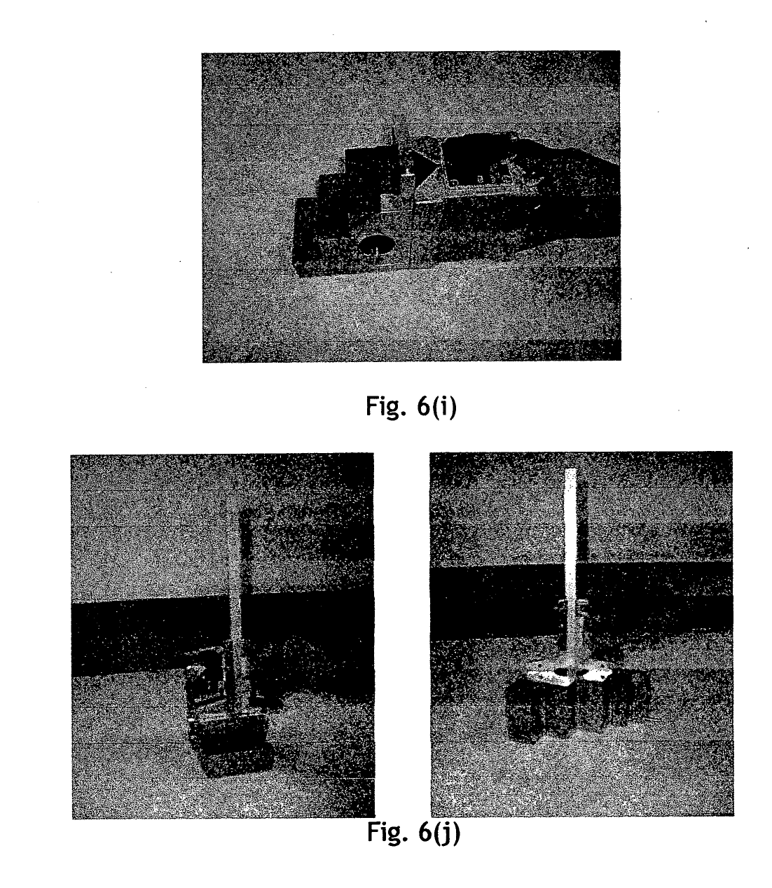

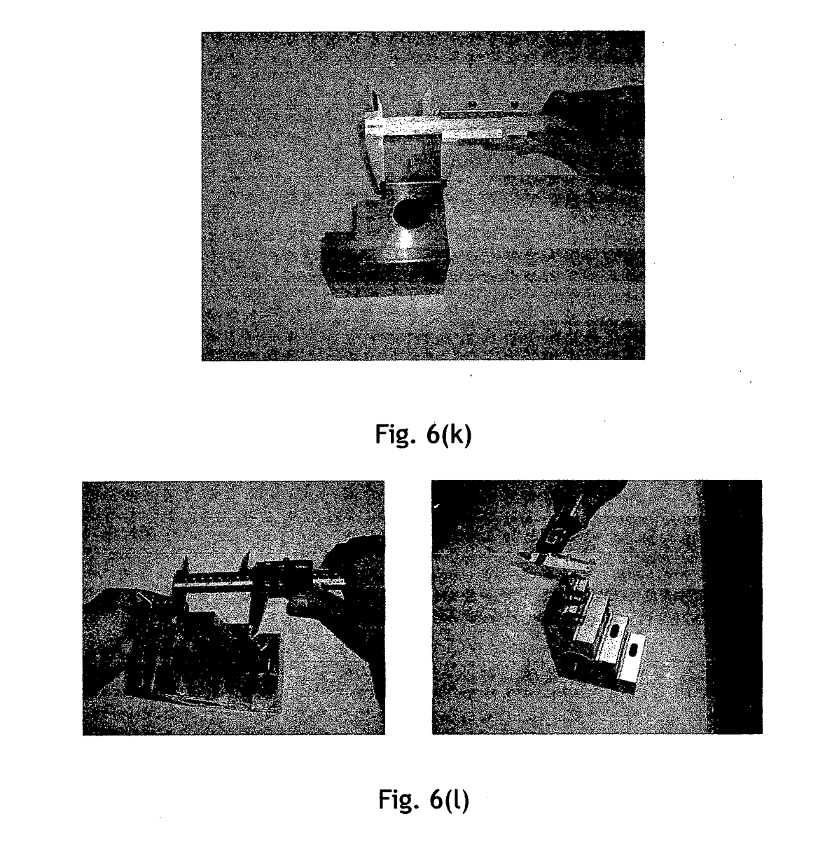

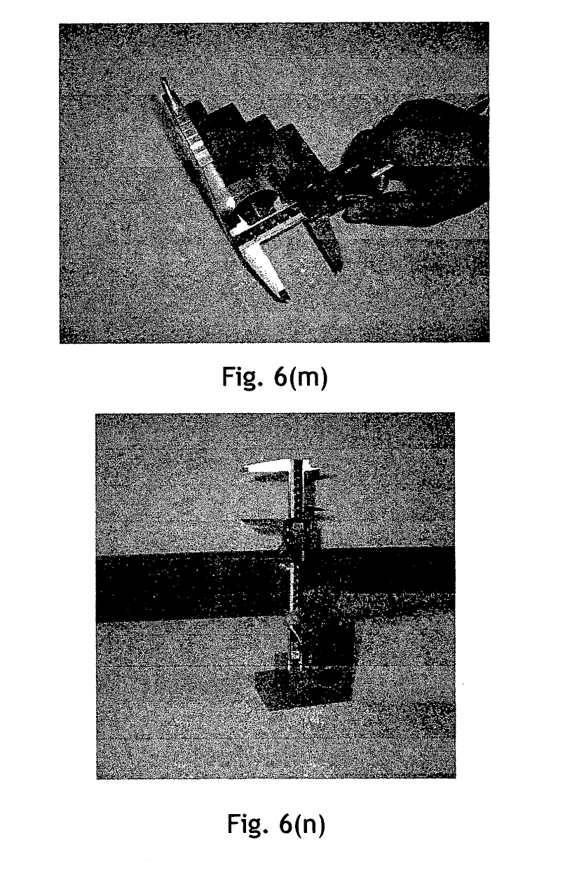

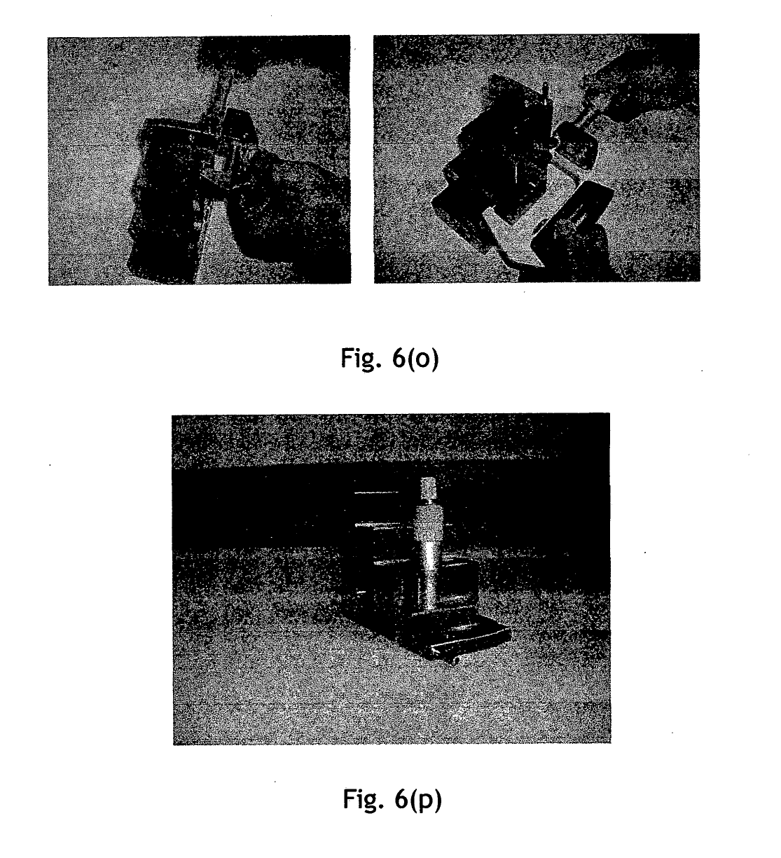

Furthermore, FIG. 5 shows an example illustrating the various measurements of the different portions of the calibration/verification gauge according to the present invention. Moreover FIG. 6(a) to (p) illustrates the method used for calibration/verification of various measuring instruments.
The calibration gauge have many steps in its design, these steps are chosen in this manner by which they can cover the whole working range of an instrument up to some extent and user can calibrate his instruments in minimum two or three range by covering entire working range of his instrument.

Example: User can calibrate Outside Micrometers of range (0˜25 mm) in steps of 5, 10, 25 mm, range (25˜50 mm) in steps of 25, 30, 50 mm, range (50˜75 mm) in steps of 50, 60, 70 & 75 mm and range (75˜100 mm) in steps of 75, 90, 100 mm.
From one side, steps are 30, 60, 90, 110 & 130 mm to check various instruments as Vernier Caliper, Digital Caliper, Micrometer and Height Gauge in different steps.

Example: User can calibrate Vernier Calipers, Digital Calipers & Height Gauges in steps of 10, 25, 30, 50, 60, 70, 90, 110, 130 mm.
There is a pin of diameter 5.0±0.003 mm at top side which is for quick reference for Vernier Caliper, Digital Caliper, Micrometer calibration etc.
There are seven small steps on top they are used to check Lever Type Dial Indicators, Plunger Type Dial Indicators and Electronic Probes etc.

Example: User can calibrate Lever Type Dial Indicators ranges from (0˜0.140 mm) in steps of 0.03, 0.1 and (0˜1.0 mm) in steps of 0.03, 0.1, 0.5 & 1.0 mm.

Example: User can calibrate Plunger Type Dial Indicators from (0˜10 mm) in steps of 0.03, 0.1, 0.5, 1, 3, 5 & 10 mm and range (0˜50 mm) in steps of 0.03, 0.1, 0.5, 1, 3, 5, 10, 25, 30 & 50 mm and range (0˜100 mm) in steps of 0.03, 0.1, 0.5, 1, 3, 5, 10, 25, 30, 50, 60, 70, 75, 90 & 100 mm.
There is an elliptical groove on step of 30 & 60 mm to check Depth Bar of Vernier Calipers, Digital Calipers and Depth Gauges.

Example: User can calibrate Depth bar of calipers in steps of 30, 60, mm.
There is a hole of ø8.5 mm at step of 110 & 130 mm, they are for calibration of Micrometer Heads for 10 & 25 mm depth.
There is an angle of 45° in fourth step to check angular devices as Bevel Protractor, Combination Sets etc. apart from that sides can be used as a perpendicular and parallel plane.

Example: User can calibrate Bevel Protractors in step of angle 45°, 90°, 180°.
From other side steps sizes are 10, 25, 50, 75, 100 mm to check Micrometers, Vernier Calipers, Digital Calipers, Height Gauges, External Calipers etc. in different steps.
There are two bores size 30 and 40 mm in sides they are for setting/calibration of Bore Gauge, Hole Test, Internal Caliper, Inside Jaws of Vernier Caliper etc. besides that the Depth Gauges can be checked with 70 mm depth.
Back side of the gauge is used for verification of V—Block, Angle Plate, Try Square etc.
All non functional areas of calibration/verification gauge are 0.2 mm down from the working surfaces, applicable to all sides of the gauge.

The exemplary embodiments/examples have been primarily described with reference to figures illustrating pertinent components of the embodiments. It should be appreciated that not all portions of a complete implementation of a practical system are necessarily illustrated or described in detail, nor are all of the varying component layout schema described. With respect to the above description then, it is to be realized that the optimum relationships of different constituents or the parts of the invention, to include many variations in function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents including material chosen for the calibration gauge may be resorted to, falling within the scope of the invention.

1. A composite calibration/verification gauge for calibrating different measuring instruments in a shop floor comprises of:
a plurality of parallely placed steps in the front portion;
a plurality of elliptical bores on the steps in different directions;
at least one measuring pin on the topmost step;
at least one central stepped bore parallel to the bottom and present on the side of the gauge;
a plurality of parallely placed smaller steps in line with the base of the measuring pin on the top most step; and
at least one tapered angle formed at one side of the said steps present in the front portion.

2. A calibration/verification gauge as claimed in claim 1, wherein the material used for the gauge is high carbon—high chromium steel and the like.

3. A calibration/verification gauge as claimed in claim 1, wherein all the sides of the calibration gauge are made perpendicular with the adjacent sides and the top sides are made parallel to the bottom sides with maximum accuracy and all non functional areas of the gauge are 0.2 mm down from the working surfaces, applicable to all sides of the gauge.

4. A calibration/verification gauge as claimed in claim 1, wherein the preferred tapered angle is made 45 degree.

5. A calibration/verification gauge as claimed in claim 1, wherein the preferred number of parallely placed steps in the front portion is five.

6. A calibration/verification gauge as claimed in claim 1, wherein the preferred number of parallely placed smaller steps along the base of the measuring pin is seven.

7. A calibration/verification gauge as claimed in claim 1, wherein the measuring pin is exactly perpendicular to the bottom plane and cylindrical in shape, the upper end of the measuring pin is shaped planar.

8. A calibration/verification gauge as claimed in claim 1, wherein the gauge is calibrated by any length standard with higher accuracy like “0” grade Gauge Block Sets or Universal Length Measuring Machine (ULM).

9. A calibration/verification gauge as claimed in claim 1, wherein the gauge has no loosen accessories/assembly.

10. A calibration/verification gauge as claimed in claim 1, wherein all working sides of the gauge block are chamfered to protect from small mechanical damages/dents and to avoid sharp edges.

11. A method for the production of the composite calibration/verification gauge comprises the steps of:
providing of the raw materials of desired block;
checking the chemical composition of the raw material;
cutting the raw material as per the disclosed design;
performing basic milling on the cut material;
performing heat treatment for obtaining desired hardness of the material;
performing sub zero treatment for better dimensional stability;
checking of the hardness of the material;
performing grinding operation to the different portions of the gauge;
performing lapping and finishing operation on the different portions of the gauge;
calibrating the gauge with different masters/standard gauges;
marking on the different portions of the gauge;
performing packing and dispatch of the finished calibration/verification gauge.

12. (canceled)

13. (canceled)
